(19) United States
(12) Patent Application Publication
(10) Pub. No.: US 2025/0117277 A1
(43) Pub. Date: Apr. 10, 2025

(54) COMPUTER METHOD AND SYSTEM FOR INCIDENT CLUSTERING

(71) Applicant: Prudential Financial, Plymouth, MN (US)

(72) Inventors: Thomas C. Kennedy, Scranton, PA (US); Michael Joseph Maclnnis, Brooklyn, NY (US); Michael P. O'Connell, Somerville, NJ (US); Michael Baker, Milford, PA (US); Edward Martinez, Rockaway, NJ (US)

(73) Assignee: Prudential Financial, Plymouth, MN (US)

(21) Appl. No.: 18/906,992

(22) Filed: Oct. 4, 2024

Related U.S. Application Data
(60) Provisional application No. 63/542,705, filed on Oct. 5, 2023.

(51) Int. Cl. G06F 11/07; G06F 40/284; G06F 40/289

(52) U.S. Cl. CPC G06F 11/0769; G06F 40/284; G06F 40/289

(57) ABSTRACT

An incident clustering system for detecting clusters among incident reports can include a data intake module configured to receive incident text strings associated with respective incident reports input by a user, a pre-processing module operatively connected to the data intake module to receive the incident text strings from the data intake module and to pre-process the incident text strings to output pre-processed text strings associated with the respective incident reports, and a token module operatively connected to the pre-processing module to receive the pre-processed text strings. The token module can be configured to identify one or more phrases-of-interest having a plurality of words in the pre-processed text strings and concatenate the plurality of words of each of one or more phrases-of-interest to output concatenated tokens associated with the respective incident reports. The system can also include a clustering module configured to receive the concatenated tokens associated with the respective incident reports and to cluster similar concatenated tokens together to cluster associated incident reports.

### CROSS REFERENCE TO RELATED APPLICATIONS

This application claims priority to U.S. Patent Application Ser. No. 63/542,705 filed Oct. 5, 2024, which is incorporated herein by reference in its entirety.

### FIELD

This disclosure relates to clustering incidents occurring on a computer network, and more particularly to detecting and analyzing incident reports relating to various applications executing on a computer network and clustering incidents according to a score value.

### BACKGROUND

Traditional incident reporting systems are simple data input systems that record incident reports. Long term trends or other common incidents cannot be detected and frequently go undetected as teams address incidents individually and use different terms to describe the incident and resolution thereof. In many cases, fixable root causes may be incurring high overall operational costs and/or business losses in many applications (e.g., in information technology incident reports, for example).

Such conventional methods and systems have generally been considered satisfactory for their intended purpose. However, there is still a need in the art for improvements. The present disclosure provides a solution for this need.

### SUMMARY

In accordance with at least one aspect of this disclosure, an incident clustering system for detecting clusters among incident reports preferably includes a data intake module configured to receive incident text strings associated with respective incident reports and a pre-processing module operatively connected to the data intake module to receive the incident text strings from the data intake module and to analyze the incident text strings to output pre-processed text strings associated with the respective incident reports. A token module is operatively connected to the pre-processing (e.g., analyzing) module to receive the pre-processed text strings. The token module is preferably configured and operative to identify one or more phrases-of-interest having a plurality of words in the pre-processed text strings, and concatenate the plurality of words of each of one or more phrases-of-interest to output concatenated tokens associated with the respective incident reports. The system further includes a clustering module configured to receive the concatenated tokens associated with the respective incident reports and to cluster similar concatenated tokens together to cluster associated incident reports, preferably according to score values (e.g., closeness values). The disclosed embodiments provide an improved computer monitoring application, system and method for clustering incidents occurring on a computer network, and more particularly to detecting and analyzing incident reports relating to various applications executing on a computer network and clustering incidents according to score value.

In certain embodiments, the pre-processing module is configured and operative to lemmatize the incident text strings, to remove stop words from the incident text strings, and/or to remove one letter words from the incident text strings to output the pre-processed text strings associated with the respective incident reports. In certain embodiments, the system includes an impact score module configured to receive or assign an arbitrary weight to each incident report based on a contextual importance of the incident report, receive a time spent value indicative of the time spent resolving each incident report, and create an impact score by multiplying the arbitrary weight by the time spent value. In certain embodiments, the clustering module is further configured to cluster the incident reports as a function of the total impact score of the cluster or a relative impact score of each incident report.

In certain embodiments, the plurality of words are two words such that the phrases-of-interest are two-word phrases. In certain embodiments, the concatenated tokens can be two words joined by an underscore or other non-alphabetic character.

In certain embodiments, the clustering module includes artificial intelligence (AI) and/or machine learning (ML). In certain embodiments, the clustering module is configured to use natural language processing (NLP). In certain embodiments, the clustering module is configured to generate vector embeddings associated with each incident report based on the concatenated tokens, and to cluster the vector embedded incident reports as a function of closeness of vector angles between incident reports.

In certain embodiments, the clustering module is configured to export clustered data to one or more analytics modules and/or visualization modules. In certain embodiments, the system includes an automatic problem detection module configured to receive the clustered data and automatically generate a problem report from identified clusters for root cause analysis and elimination.

In accordance with at least one aspect of this disclosure, a computer system and method for detecting clusters among incident reports includes one or more processors and/or one more servers, and one or more memories storing instructions that, when executed by the one or more processors and/or servers, cause the computer system to receive incident text strings associated with respective incident reports (e.g., input by a user) so as to pre-process the incident text strings to generate output pre-processed text strings associated with the respective incident reports. The computer system further preferably identifies one or more phrases-of-interest having a plurality of words in the pre-processed text strings to concatenate the plurality of words of each of the one or more phrases-of-interest to output concatenated tokens associated with the respective incident reports. The system is further configured to cluster, from the concatenated tokens, similar concatenated tokens together to cluster associated incident reports.

In accordance with at least one aspect of this disclosure, a non-transitory computer readable medium can include computer executable instructions configured to cause a computer to perform a method. The method can include receiving incident text strings associated with respective incident reports input by a user, pre-processing the incident text strings to output pre-processed text strings associated with the respective incident reports, identifying one or more phrases-of-interest having a plurality of words in the pre-processed text strings, concatenating the plurality of words of each of the one or more phrases-of-interest to output concatenated tokens associated with the respective incident reports, and clustering, from the concatenated tokens, similar concatenated tokens together to cluster associated incident reports. The method further includes any other suitable method(s) and/or portion(s) thereof and/or any suitable functions disclosed herein (e.g., as described above with respect to the incident clustering system).

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 illustrates an example communication network utilized with one or more of the illustrated embodiments.

FIG. 2 illustrates an example network device/node utilized with one or more of the illustrated embodiments.

FIG. 3 is a schematic diagram of an embodiment of an incident clustering system in accordance with this disclosure.

FIG. 4 is a schematic diagram of an embodiment of a logic flow of one or more embodiments of a system in accordance with this disclosure.

FIG. 5 is flow diagram of an embodiment of a method in accordance with this disclosure.

FIG. 6 illustrates an embodiment of a GUI in accordance with this disclosure, showing problem detection by configuration item (CI).

FIG. 7 illustrates an embodiment of a GUI in accordance with this disclosure, showing a unified customer dashboard having a production profiling report having a problem cluster button.

FIG. 8 illustrates an embodiment of a GUI in accordance with this disclosure, showing potential problem clusters for unified customer dashboard along with a word cloud showing common two word phrases.

FIG. 9 illustrates an embodiment of a GUI in accordance with this disclosure, showing a Cluster 0 profiling report for the unified customer dashboard.

FIG. 10 illustrates an embodiment of a GUI in accordance with this disclosure, showing top potential problems.

FIG. 11 illustrates an embodiment of a GUI in accordance with this disclosure, showing incident details for the unified customer dashboard for Cluster 0.

### DETAILED DESCRIPTION

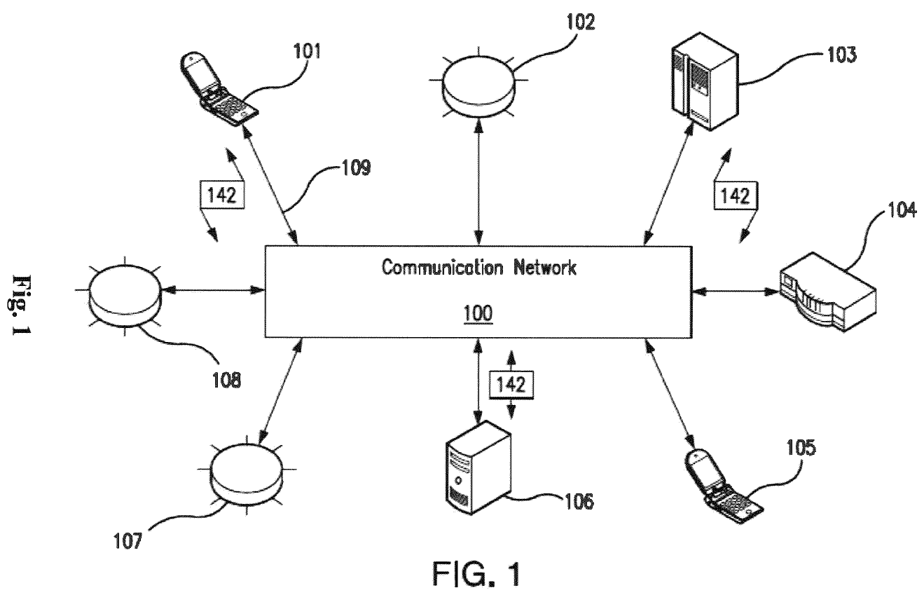

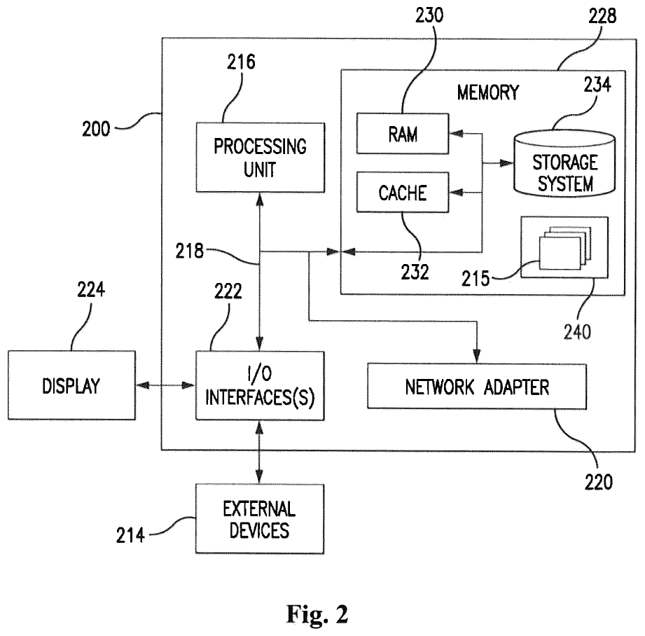

Reference will now be made to the drawings wherein like reference numerals identify similar structural features or aspects of the subject disclosure. For purposes of explanation and illustration, and not limitation, an illustrative view of an embodiment of a network in accordance with the disclosure is shown in FIG. 1 and is designated generally by reference character 100. Other views, embodiments, and/or aspects of this disclosure are illustrated in FIGS. 2-12. Certain embodiments described herein can be used to cluster large amounts of data to detect and resolve underlying issues based on text input, for example.

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103 (e.g., network monitoring devices), smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

FIG. 2 is a schematic block diagram of an example network computing device 200 (e.g., client computing monitoring device 103, server 106, etc.) that may be used (or components thereof) with one or more embodiments described herein (e.g., as one of the nodes shown in the network 100) for incident clustering (e.g., using one or more machine learning (ML) techniques). As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, particularly for e.g., for incident clustering, e.g., using machine learning (ML) techniques. These determined probabilities of incident occurrences advantageously provide early indication of the likelihood of an incident occurring via probabilistic machine learning modeling.

It is to be understood and appreciated that computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network 100. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments such as, e.g., for incident clustering, e.g., using machine learning (ML) techniques.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein for detecting one or more anomalies in one or more networked computer devices (e.g., 103, 106).

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

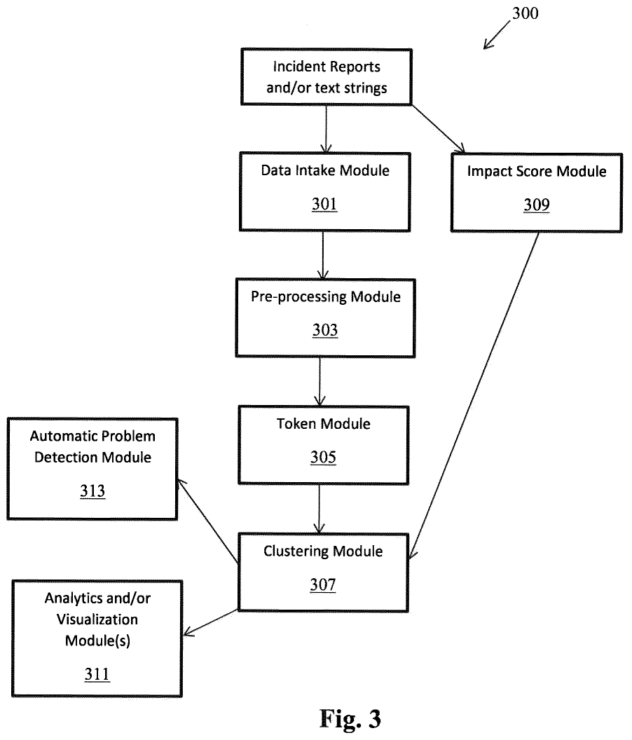

In accordance with at least one aspect of this disclosure, referring additionally to FIG. 3, an incident clustering computer system 300 (including one or more components of computer system 200 of FIG. 2) for detecting clusters among incident reports preferably includes a data intake module 301 configured to receive incident text strings associated with respective incident reports (e.g., input by a user). In certain embodiments, the incident reports can have one or more free text inputs (e.g., certain information technology incident reports with problem description and resolution notes). It is to be understood and appreciated that the disclosed embodiments provide an improved computer monitoring application, system and method for clustering incidents occurring on a computer network, and more particularly to detecting and analyzing incident reports relating to various applications executing on a computer network and clustering incidents according to score value.

The system 300 preferably includes a pre-processing module 303 operatively connected to the data intake module 301 to receive the incident text strings from the data intake module 301 and to pre-process/analyze the incident text strings 301 to generated outputted pre-processed text strings associated with the respective incident reports. In certain embodiments, the pre-processing module 303 is configured and operative to lemmatize (e.g., to reduce the different forms of a word to one single form) the incident text strings, so as to remove stop words from the incident text strings, and/or to remove one letter words from the incident text strings to output the pre-processed text strings associated with the respective incident reports.

The system 300 further preferably includes a token module 305 operatively connected to the pre-processing module 303 for receiving the pre-processed text strings. The token module 305 is preferably configured and operative to identify one or more phrases-of-interest having a plurality of words in the pre-processed text strings. In certain embodiments, the phrases-of-interest includes one or more manually predefined phrases. In certain embodiments, the one or more phrases includes frequently appearing multiword phrases in the text strings determined by the token module 305 (e.g., via one or AI/ML techniques, or other suitable comparative processing techniques utilizing referenced against historical data). The token module 305 in certain embodiments is configured to concatenate the plurality of words of each of one or more phrases-of-interest so as to generate outputted concatenated tokens associated with the respective incident reports.

For instance, in certain embodiments, the plurality of words in the preprocessed text string are two words such that the phrases-of-interest are two-word phrases. In certain embodiments, the concatenated tokens are two words joined by an underscore or other non-alphabetic character. In certain embodiments, the plurality of words are more than two words (e.g., three-words, up to N-words). For example, certain embodiments utilize bigrams (N=2) where the amount of text fed as input is not sufficient to meaningfully find N>2 sets of words.

The system 300 also includes a clustering module 307 configured and operative to receive the concatenated tokens from the token module 305 associated with the respective incident reports. The clustering module 307 is configured to cluster similar concatenated tokens together so as to cluster associated incident reports. In certain embodiments, the clustering module 307 is implemented utilizing one or more AI/ML techniques, for example.

In certain embodiments, the system 300 includes an impact score module 309 configured to receive and/or assign an arbitrary weight to each incident report preferably based on a contextual importance of the incident report, receive a time spent value indicative of the time spent resolving each incident report, and create an impact score by multiplying the arbitrary weight by the time spent value. In certain embodiments, the clustering module 307 is further configured to cluster the incident reports as a function of a relative impact score of each incident report. In certain embodiments, the clustering module 307 is further configured to cluster the incident reports as a function of the total impact score of a resulting cluster (to impart more importance on clusters having high aggregate incident scores, e.g., smaller clusters with high impact can be separated from other data).

In certain embodiments, the clustering module 307 includes utilization of one or more artificial intelligence (AI) and/or machine learning (ML) techniques. In certain embodiments, the clustering module 307 is configured to use natural language processing (NLP) techniques. In certain embodiments, the clustering module 307 is configured to generate vector embeddings associated with each incident report based on the concatenated tokens, and to cluster the vector embedded incident reports as a function of closeness of vector angles between incident reports. For instance, the closeness of vector angles can be measured using cosine similarity using the cosine of the angle between two vectors, which is a measure of how similar the vectors are. The cosine similarity is calculated by dividing the dot product of the vectors by the product of their lengths. The value of cosine similarity is independent of the vectors' magnitudes, and only depends on their angle. Additionally, the closeness of vector angles can be measured using angular distance which is the measure of the angle between two vectors in three-dimensional space, or using orthogonal vectors in which vectors that are perpendicular to each other, forming a 90° angle, wherein the dot product of an orthogonal vector is always zero.

In certain embodiments, the clustering module 307 is configured to export clustered data to one or more analytics modules and/or visualization modules (so as to be displayed in graphical representation to a user). In certain embodiments, the system 300 preferably includes an automatic problem detection module 307 configured to receive the clustered data and automatically generate a problem report from identified clusters for root cause analysis and elimination, for example.

It is to be appreciated and understood, that while the impact score module 309 is shown connected to the clustering module 307 in FIG. 3, the impact score can be factored in after clustering at the clustering module 307. For example, in certain embodiments, the impact score module 309 is connected to module(s) 311 and/or module 313 to provide the impact score after clustering of similar tokens in order to apply a weight to each cluster. Also, the impact score module 309 receives incident report data from any suitable module(s), e.g., the data intake module or from any other suitable input. While an embodiment of a system 300 is shown having a certain arrangement of modules and flow of data, other suitable arrangements are contemplated herein.

In accordance with at least one aspect of this disclosure, a computer system and method for detecting clusters among incident reports preferably includes one or more processors and/or one more servers, and one or more memories storing instructions that, when executed by the one or more processors and/or servers, cause the computer system to receive incident text strings associated with respective incident reports input by a user, pre-process the incident text strings to output pre-processed text strings associated with the respective incident reports. It then identifies one or more phrases-of-interest having a plurality of words in the pre-processed text strings, concatenate the plurality of words of each of the one or more phrases-of-interest to output concatenated tokens associated with the respective incident reports. Clustered, from the concatenated tokens, similar concatenated tokens are clustered together so as to cluster associated incident reports.

In accordance with at least one aspect of this disclosure, a non-transitory computer readable medium can include computer executable instructions configured to cause a computer to perform a method. The method can include receiving incident text strings associated with respective incident reports input by a user, pre-processing the incident text strings to output pre-processed text strings associated with the respective incident reports, identifying one or more phrases-of-interest having a plurality of words in the pre-processed text strings, concatenating the plurality of words of each of the one or more phrases-of-interest to output concatenated tokens associated with the respective incident reports, and clustering, from the concatenated tokens, similar concatenated tokens together to cluster associated incident reports. The method can include any other suitable method(s) and/or portion(s) thereof and/or any suitable functions disclosed herein (e.g., as described above with respect to the incident clustering system).

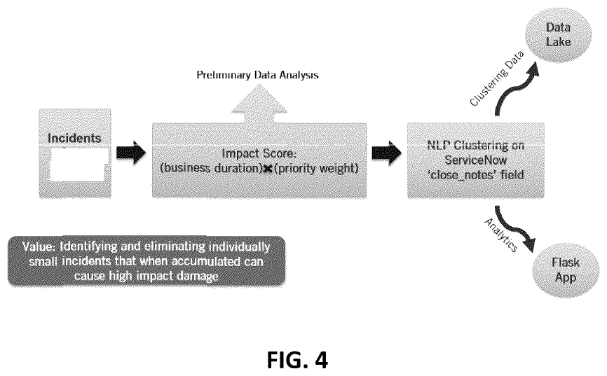

With reference to FIG. 4, shown is a schematic diagram of an embodiment of a logic flow of one or more embodiments of a system in accordance with this disclosure. Incidents from the data source can include only human entered data and have machine information removed, for example. Certain embodiments remove “and”, “the”, and similar single words, lemmatize the data, and create two-word tokens. One or more certain embodiments also create an impact score for each incident based on the effect to the business. For example, a priority weight is assigned to each incident (e.g., which can be arbitrary and based on what is important to the business or what causes the most business loss). Two-word string tokens are provided into a natural language processing (NLP) machine learning algorithm for processing thereof. For instance, the algorithm clusters similar strings and/or tokens made of strings. During or after clustering, the impact score is applied using the incident ID's which can be preserved, and the software dynamically determine what defines each cluster to determine total weighted score of a cluster.

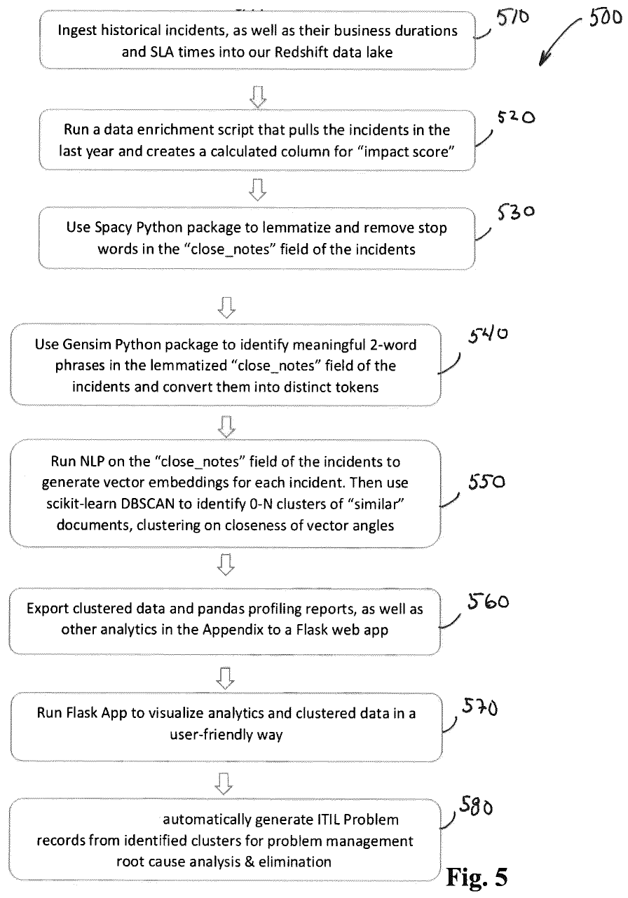

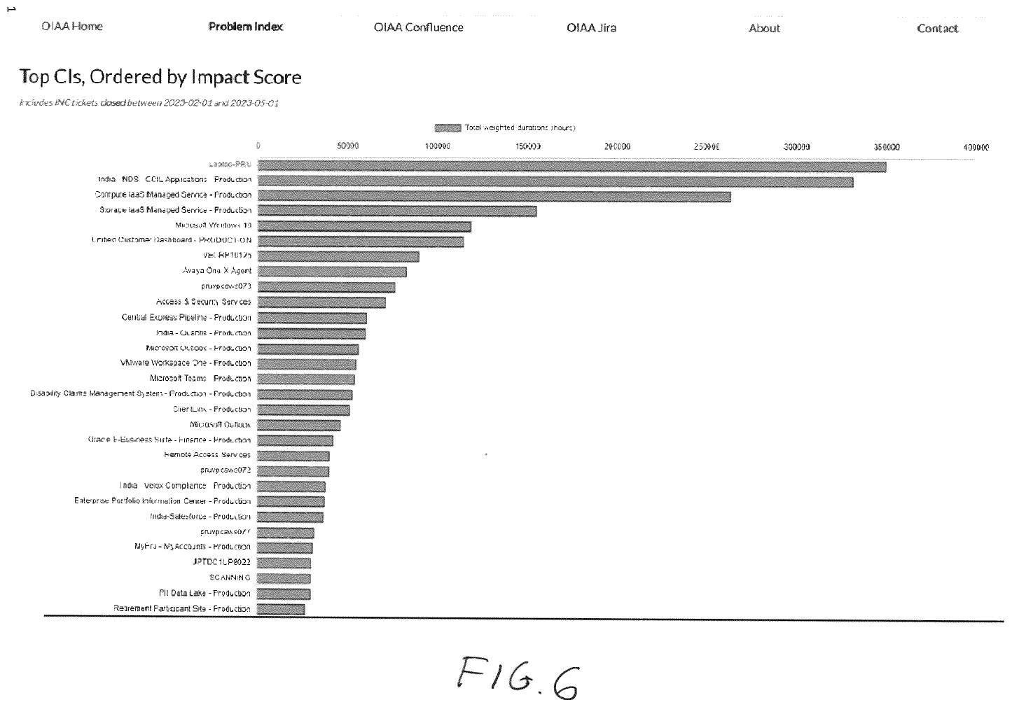

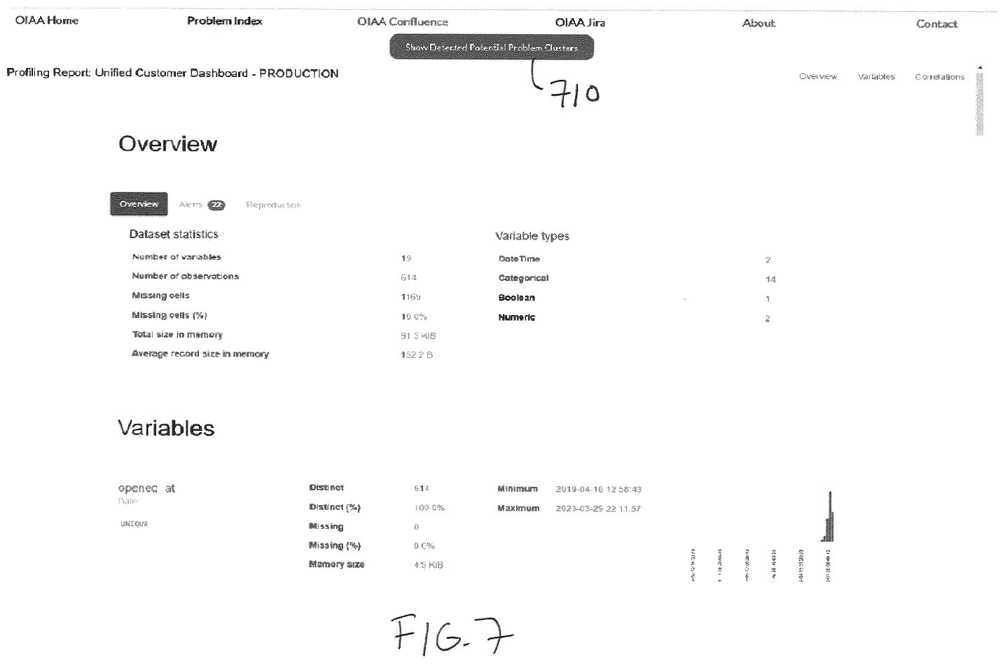

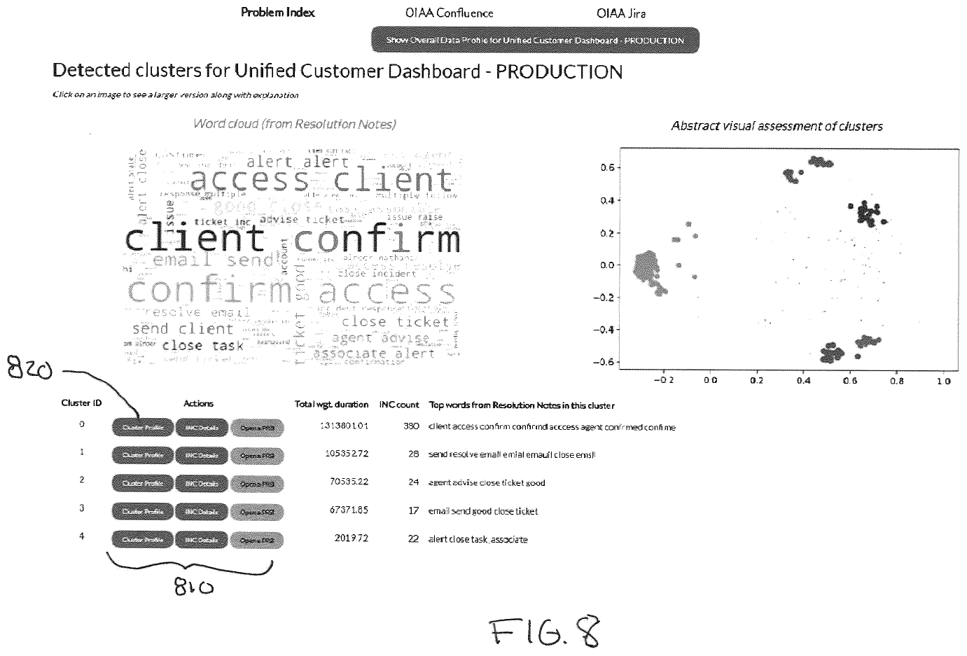

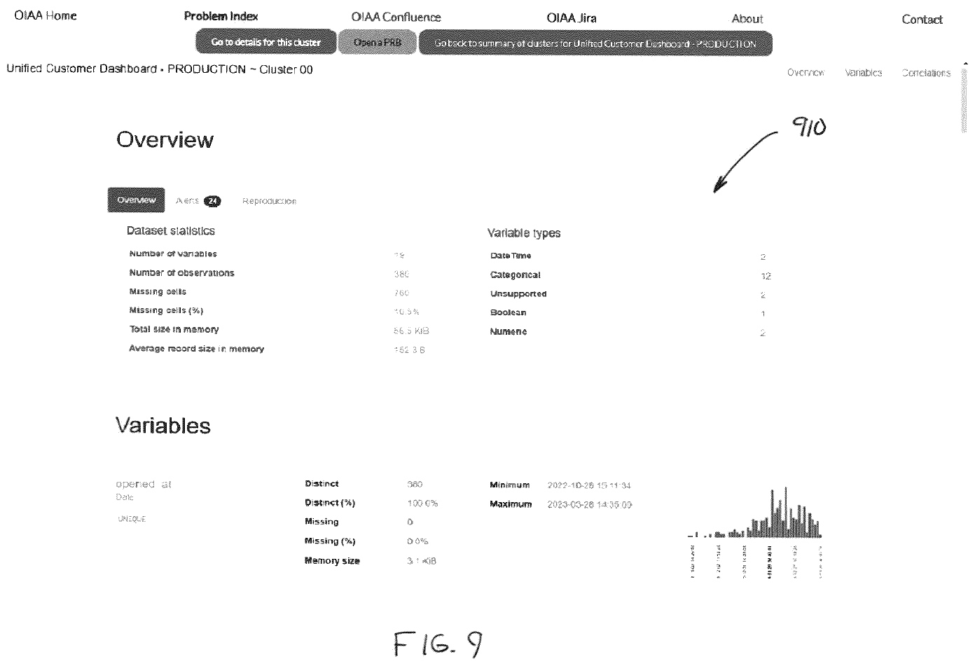

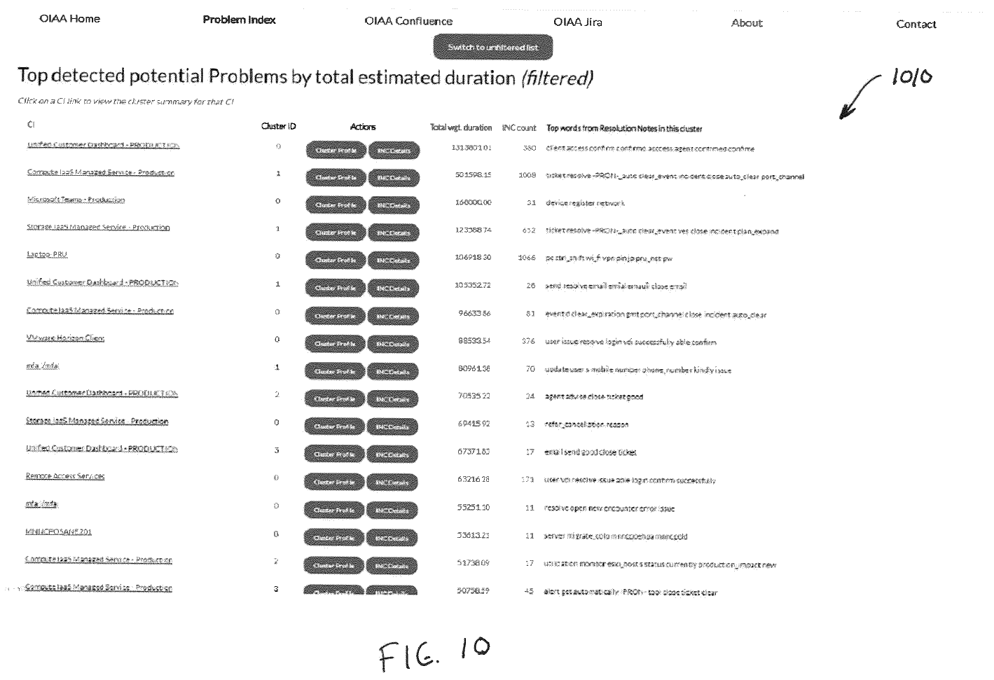

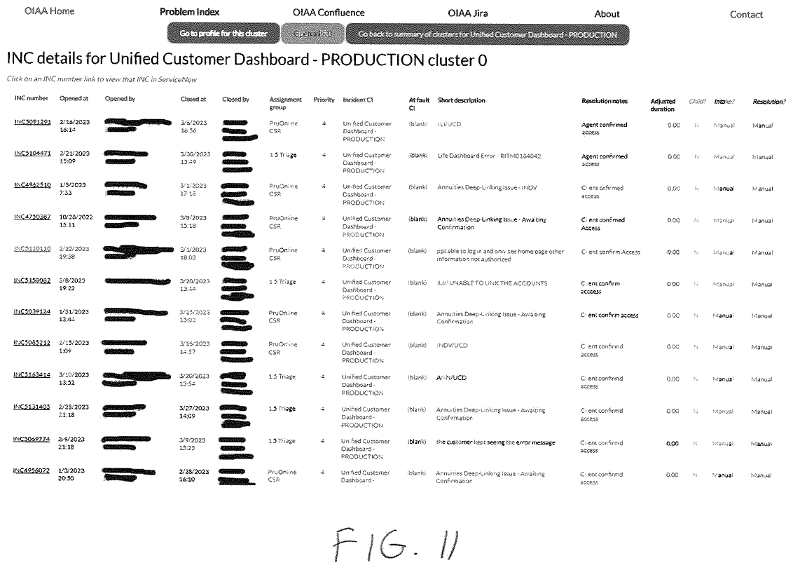

With reference to FIG. 5, shown is flow diagram of an embodiment of a method in accordance with this disclosure in accordance with process 500. For example, as shown, a model workflow can ingest historical incidents (step 510), as well as their business durations and SLA times into our Redshift data lake, run a data enrichment script that pulls the incidents in the last year and creates a calculated column for impact score (step 520). Next, at step 530, a Spacy Python package is utilized to lemmatize and remove stop words in the “close_notes” field of the incidents. At step 540, a Gensim Python package is preferably utilized to identify meaningful 2-word phrases in the lemmatized “close_notes” field of the incidents and convert them into distinct tokens. Next, at step 550, one or more NLP techniques are utilized on the “close_notes” field of the incidents to generate vector embeddings for each incident. Certain embodiments can then use scikit-learn DBSCAN to identify 0-N clusters of similar documents, clustering on closeness of vector angles. At step 560, certain embodiments export clustered data and pandas profiling reports, as well as other analytics in an Appendix to a Flask web app. The Flask App is then preferably executed to visualize analytics (e.g., on a GUI of a user computing display) and clustered data in a user-friendly way (step 570). Next, at step 580, ITIL problem records are generated from identified clusters for problem management root cause analysis and elimination. For instance, FIG. 6 illustrates an embodiment of a GUI in accordance with this disclosure, showing problem detection by configuration item (CI). FIG. 7 illustrates an embodiment of a GUI in accordance with this disclosure, showing a unified customer dashboard having a production profiling report having a problem cluster button. FIG. 8 illustrates an embodiment of a GUI in accordance with this disclosure, showing potential problem clusters for unified customer dashboard along with a word cloud showing common two word phrases (e.g., accessed after selecting the problem cluster button (710) of the embodiment of FIG. 7, also showing a plurality of action buttons 810 including a cluster profile button (e.g., 820) for each cluster ID. FIG. 8 illustrates a screen shot 800 of a GUI in accordance with an illustrated embodiment identifying potential problem clusters in unified customer dashboard along with a word cloud 830 indicating/clustering common word phrases. FIG. 9 illustrates an embodiment of a GUI in accordance with this disclosure, showing a Cluster 0 profiling report 910 for the unified customer dashboard, (e.g., accessed after selecting the cluster profile button 820 of FIG. 8). FIG. 10 illustrates an embodiment of a GUI in accordance with this disclosure, showing top potential problems (e.g., sorted by CI and Cluster) 1010. And FIG. 11 illustrates an embodiment of a GUI in accordance with this disclosure, showing incident details 1110 for the unified customer dashboard for Cluster 0 (e.g., the redacted portions indicate placeholders for names.

It is to be appreciated and understood certain embodiments include incident clustering using one or more NLP techniques. In certain embodiments, the goal of the incident clustering model is to cluster incidents together based on their linguistically similar free text fields from an incident management system. These clusters provide a better understanding of similar incidents happening at high volumes that are causing problems within IT systems. This model provides a reduction in time to finding root cause analysis, providing IT asset owners a better understanding of high impact incidents causing damage to their applications or services.

In certain embodiments, ITIL incident clustering model clusters ITIL incidents together based on linguistically similar human-entered free-text fields. These clusters indicate where similar ITIL incidents are happening at high volumes that are causing problems within IT systems, but are “spread out” (chronologically, topically, etc.) such that the human operators are not aware that there is a systemic problem. Embodiments can lead to a reduction in time to finding root cause analysis, and generally provide IT asset owners a better understanding of where fixable root causes may be incurring high overall operational costs and/or business losses.

In certain embodiments, the data used in the model is retrieved from “incident” and “SLA” (Service Level Agreement) records originating in IT workflow management tools (e.g., ServiceNow™). Prior to running a clustering script and model, embodiments preferably perform preliminary data engineering to create for each ITIL incident record additional columns that can be used in analysis. In certain embodiments, the size of the dataset consist of the incidents in the last year, and the number of records can be roughly around 1,100,000 in some cases.

Specifically, certain embodiments calculate an approximated relative business cost value for each ITIL incident. For example, ITIL incidents are provided a priority value from P1 to P5, with P1 being the most urgent and important incidents. Also, ITIL incidents have a business duration (i.e. how much of the temporal duration was causing actual business impact). Certain embodiments approximate the relative business cost of each ITIL incident record by multiplying the business duration of that incident by a weighting factor based on the priority of that incident. For instance, an embodiment of weightings used are as follows: P1s are ×20, P2s are ×15, P3s are ×3, P4s are ×2 and P5s are ×1. These weightings can be generated from the subject matter expertise of personnel, for example. Other suitable manners to generate weightings is contemplated herein.

It is to be understood and appreciated that the approximated relative business cost, which in certain embodiments, is not a dollar-value cost per incident, but is a relative cost value, to be used when comparing a grouping of one or more incidents to another grouping of one or more incidents. The total relative business cost of a grouping of incidents is the sum of the individual approximated relative business cost values for each individual incident in that group.

During prior normal business workflows, a summary of what was done to resolve any given incident was entered as free text into the incident records, which is the ‘close_notes’ field in ServiceNow. Embodiments can read in the resolved incidents from the last year and processes the data to a drop duplicate records {duplicate ‘incident’ IDs}, and include records with human-entered data. Certain embodiments focus on the ‘close_notes’ field, which remove common stopwords, as well as any 1-letter words (e.g., via the library Spacy for example), and ensure the data is alphabetic characters and lowercase, for example. These cleaned data elements may consist of lowercase ‘words’ (sets of alphabetic characters separated by spaces) and are tied back to their originating incident records.

Next, certain embodiments process these cleaned data elements to identify common bigrams, i.e., where two ‘words’ are detected next to each other frequently enough that they warrant being combined into a single token (e.g., in this case, by joining the two ‘words’ together by replacing the space between them with a ‘_’ (underscore) character). This operation can be done via the library Gensim, for example. The revised data elements (e.g., ‘documents’) with the newly-identified bigrams can be tied back to their originating incident records.

In certain embodiments, a neural network is trained on the individual ‘documents’ from each incident record, e.g., where there is a high dimensional vector (e.g., a 20-dimensional vector) for each unique word plus a high dimensional vector (e.g., a 20-dimensional vector) for each ‘document’. Other suitable dimensional vectors are contemplated herein. The model is preferably trained using contextual prediction, e.g., given a text ‘window’ of five (5) words, to improve the accuracy of the middle word prediction based on the vectors of the surrounding words. Each overall ‘document’ can then also be given a linguistic value based on the order and number of the word vectors within that ‘document’. Such an operation can be done via the Doc2Vec model in the library Gensim, for example.

In certain embodiments, once the model has been trained and generated unique linguistic vectors for each incident record, all incident records are organized by which IT asset or service each incident was associated with. For instance, in ServiceNow this is referred to as the “configuration item” (CI), which is a business service, an individual device, a component of an application, or other item. The CIs are then prioritized by the total relative business cost of the incidents associated to that CI. The top CIs (e.g., the CIs which represent the highest total relative business cost) can be processed further. It can be chosen how many CIs to include in processing by either selecting a fixed number (e.g., the top 100 CIs), or all CIs for which the total relative business cost exceeds a human-selected value, or the top N % CIs (e.g., where N % could be, for example, 80%).

For each of the top CIs, certain embodiments generate an automated data exploration webpage displaying simple metrics on the various fields in the incident records (e.g., done via the library Pandas Profiling) and preferably generate and display a wordcloud based on the processed free-text ‘documents’ associated with all the incidents (e.g., done via the library “WordCloud”).

In certain embodiments, clusters of incidents are detected based on the similarity of the angles of the ‘document’ vectors for associated the incidents. For instance, ‘documents’ with very low angles between them can be found to have highly similar linguistic meaning. In certain embodiments, the minimum cluster size, i.e., the minimum number of incidents to be considered a cluster, is defined to be 10 unless the number of incidents overall associated with the CI is greater than 1000, in which case cluster size is defined to be equal to {#of associated incidents}/100. In certain embodiments, cluster detection is executed using an epsilon value of 0.15. This process can be done via the DBSCAN portion of the library scikit-learn.

In certain embodiments, for each CI, for each cluster detected within the incidents for that CI, the total relative business cost values for each incident in that cluster is summed to generate an overall relative business cost value for that cluster. Certain embodiments also identify the top five (5) most-frequently-appearing words in the ‘documents’ from the incidents in that cluster, and associate those as well to the cluster. It is noted this is useful for users to see at a glance generally the type of content which led to those incidents being clustered.

Certain embodiments also use principal component analysis to perform dimensionality reduction on all the ‘document’ vectors for all the incidents associated with each CI, generalizing each vector down to a 2-dimensional (e.g., X and Y) coordinate. Certain embodiments then display each incident as a dot on the screen. Certain embodiments assign each 1-N clusters (if any) found for those incidents a unique color, and render all the incidents as a dot of the color for the cluster they were found in (e.g., or black, if an incident was not part of any cluster).

In certain embodiments, given a set of detected clusters of linguistically similar incidents, and an overall relative business cost for each cluster, valuable data is provided to the IT asset owners and managers to automate further workflows toward eliminating root causes (and thus preventing future incidents and business costs).

Certain embodiments include an interactive GUI interface configured and operative such that users sort clusters by overall relative business cost, allowing them to quickly identify and focus on clusters with the highest relative costs. Certain embodiments additionally automate the creation of ITIL problem tickets, e.g., workflows oriented around eliminating root causes and preventing future incidents by comparing the overall relative business costs of clusters to user-defined thresholds. In certain embodiments, if the overall cost is greater than a ‘minor’ threshold, an ITIL problem ticket is automatically opened and assigned to the IT asset owner of the associated CI. In certain embodiments, if the overall costs is greater than a ‘major’ threshold, the ITIL problem ticket is assigned directly to a problem team.

Embodiments can include an incident Clustering AI/ML model designed to identify high volumes of incidents that may be individually causing low impact, but at high volume in the aggregate are collectively causing significant business impact. Being able to target these aggregate problems and eliminate the common root causes provide reductions in staff time needed to resolve, lower business costs, and less negative reputation impacts.

Analysis performed after clustering can be reduced with dimensionality reduction or PCA (principal component analysis). Certain embodiments thus reduce the dimensions of the incidents down to just two (2) for example, so the incidents can be visualized on an GUI in an x-y plane. Certain embodiments color the incidents in each cluster differently, to provide a visualization of how tight the incidents in each cluster are.

As disclosed above, certain embodiments include a light-weight Flask app that provides visualization of the model results and outputted data in a user-friendly way where users can easily visualize, and comprehend the displayed data. For instance, users may primarily use this tool can be a Network Operations Center (NOC), as well as the IT asset owners that own the assets that are causing the most impact to the business. For the NOC, ITIL users will use this tool to better understand the problems that might be arising from large volumes of lower priority incidents that are causing high impact to the business. The ITIL problem solving user may use this tool to analyze the potential problems that incidents are causing when grouped by IT asset and by their similar resolution notes.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A computer incident clustering system for detecting clusters among incident reports, comprising:
a data intake module configured to receive, from a computer network, incident text strings associated with respective incident reports;
a pre-processing module operatively connected to the data intake module being configured to receive the incident text strings from the data intake module and to analyze the incident text strings to generate output pre-processed text strings associated with the respective incident reports;
a token module operatively connected to the pre-processing module being configured to receive the analyzed text strings, wherein the token module is further configured to:
identify one or more phrases-of-interest having a plurality of words in the pre-processed text strings; and
concatenate the plurality of words of each of one or more phrases-of-interest to output concatenated tokens associated with the respective incident reports; and
a clustering module configured to receive the concatenated tokens associated with the respective incident reports and being further configured to cluster similar concatenated tokens together to cluster associated incident reports.

2. The computer system of claim 1, wherein the pre-processing module is further configured to lemmatize the incident text strings, to remove stop words from the incident text strings, and/or to remove one letter words from the incident text strings to output the pre-processed text strings associated with the respective incident reports.

3. The computer system of claim 2, further comprising an impact score module configured to:
assign an arbitrary weight to each incident report based on a contextual importance of the incident report;
receive a time spent value indicative of the time spent resolving each incident report; and
create an impact score by multiplying the arbitrary weight by the time spent value.

4. The computer system of claim 3, wherein the clustering module is further configured to cluster the incident reports as a function of the total impact score of the cluster.

5. The computer system of claim 3, wherein the clustering module is further configured to cluster the incident reports as a function of the relative impact score of each incident report.

6. The computer system of claim 1, wherein the plurality of words are two words such that the phrases-of-interest are two-word phrases.

7. The computer system of claim 6, wherein the concatenated tokens are two words joined by an underscore or other non-alphabetic character.

8. The computer system of claim 2, wherein the clustering module includes artificial intelligence (AI) and/or machine learning (ML) techniques to cluster similar concatenated tokens together to cluster associated incident reports.

9. The computer system of claim 8, wherein the clustering module is further configured to use natural language processing (NLP) to cluster similar concatenated tokens together to cluster associated incident reports.

10. The computer system of claim 9, wherein the clustering module is configured to generate vector embeddings associated with each incident report based on the concatenated tokens, and to cluster the vector embedded incident reports as a function of closeness of vector angles between incident reports.

11. The computer system of claim 10, wherein the clustering module is further configured to export clustered data to one or more analytics modules.

12. The computer system of claim 10, wherein the clustering module is further configured to export clustered data to one or more visualization modules for visualizing the clusters associated with incident reports on a computer display.

13. The computer system of claim 10, further comprising an automatic problem detection module configured to receive the clustered data and automatically generate a problem report from identified clusters for root cause analysis and elimination.

14. A computer-implemented method for detecting clusters among incident reports, comprising the steps:
receiving, in a computer processor, from a computer network, electronic data containing incident text strings associated with respective incident reports;
analyzing, in the computer processor, the incident text strings to generate output containing pre-processed text strings associated with the respective incident reports;
identifying, in the computer processor, one or more phrases-of-interest having a plurality of words in the pre-processed text strings;
concatenating, in the computer processor, the plurality of words of each of the one or more phrases-of-interest to generate output containing concatenated tokens associated with the respective incident reports; and
clustering, in the computer processor, from the concatenated tokens, similar concatenated tokens together to cluster associated incident reports.

15. The computer-implemented method as recited in claim 15, wherein the analyzing step further includes lemmatizing the incident text strings, to remove stop words from the incident text strings, and/or to remove one letter words from the incident text strings to output the pre-processed text strings associated with the respective incident reports.

16. The computer-implemented method as recited in claim 16, further including the steps:
assigning an arbitrary weight to each incident report based on a contextual importance of the incident report;
receiving a time spent value indicative of the time spent resolving each incident report; and
creating an impact score by multiplying the arbitrary weight by the time spent value.

17. The computer-implemented method as recited in claim 17, wherein the clustering step further includes clustering the incident reports as a function of the total impact score of the cluster.

18. The computer-implemented method as recited in claim 17, wherein the clustering step further includes clustering the incident reports as a function of the relative impact score of each incident report.

19. The computer-implemented method as recited in claim 15, wherein the plurality of words are two words such that the phrases-of-interest are two-word phrases.

20. The computer-implemented method as recited in claim 20, wherein the concatenated tokens are two words joined by an underscore or other non-alphabetic character.

21. The computer-implemented method as recited in claim 16, wherein the clustering step utilizes artificial intelligence (AI) and/or machine learning (ML) techniques to cluster similar concatenated tokens together to cluster associated incident reports.

22. The computer-implemented method as recited in claim 22, wherein the clustering step utilizes natural language processing (NLP) to cluster similar concatenated tokens together to cluster associated incident reports.

23. The computer-implemented method as recited in claim 23, wherein the clustering step further generates vector embeddings associated with each incident report based on the concatenated tokens to cluster the vector embedded incident reports as a function of closeness of vector angles between incident reports.

24. The computer-implemented method as recited in claim 24, wherein the clustering step further exports clustered data to one or more analytics modules.

25. The computer-implemented method as recited in claim 24, wherein the clustering step further exports clustered data to one or more visualization modules for visualizing the clusters associated with incident reports on a computer display.

26. The computer-implemented method as recited in claim 24, further including the step of automatically generate a problem report from identified clusters for root cause analysis and elimination.
